(19) United States
(12) Patent Application Publication
(10) Pub. No.: US 2025/0253442 A1
(43) Pub. Date: Aug. 7, 2025

(54) BATTERY INSULATION SYSTEM FOR A HYBRID OR ELECTRIC VEHICLE

(71) Applicant: FORD GLOBAL TECHNOLOGIES, LLC, Dearborn, MI (US)

(72) Inventors: Xiaogang ZHANG, Novi, MI (US); Haibo Zhao, Northville, MI (US)

(21) Appl. No.: 18/430,164

(22) Filed: Feb. 1, 2024

(51) Int. Cl. H01M 10/658; H01M 50/204; H01M 50/249; H01M 50/291; H01M 50/293

(52) U.S. Cl. CPC H01M 10/658; H01M 50/204; H01M 50/249; H01M 50/291; H01M 50/293; H01M 2220/20

(57) ABSTRACT

A battery includes a plurality of cells and a plurality of thermal barriers. The plurality of cells is configured to store electrical energy. Each of the thermal barriers is disposed between adjacent cells of the plurality of cells. Each thermal barrier includes solid regions and defines cutouts between the solid regions. Each solid region and each cutout within each thermal barrier are aligned along a plane. Each solid region and each cutout within each thermal barrier have a dimension that is perpendicular to the plane and extends between the corresponding adjacent cells.

### TECHNICAL FIELD

The present disclosure relates to hybrid or electric vehicles and batteries for hybrid or electric vehicles.

### BACKGROUND

Hybrid or electric vehicles may be propelled by an electric machine that draws power from a battery.

### SUMMARY

A battery for an electrically powered vehicle includes a plurality of cells and a plurality of thermal barriers. The plurality of cells is configured to store electrical energy and discharge the electrical energy to propel the vehicle. The plurality of thermal barriers is disposed between adjacent cells of the plurality of cells. Each thermal barrier includes planar regions. Each thermal barrier defines voids between the planar regions. Each planar region and each void within each thermal barrier are aligned in a coplanar arrangement within a gap defined between the corresponding adjacent cells. Each planar region and each void within each thermal barrier extend transversely between the corresponding adjacent cells orthogonally to the coplanar arrangement.

A battery includes a plurality of cells and a plurality of thermal barriers. The plurality of cells is configured to store electrical energy. Each of the thermal barriers is disposed between adjacent cells of the plurality of cells. Each thermal barrier includes solid regions and defines cutouts between the solid regions. Each solid region and each cutout within each thermal barrier are aligned along a plane. Each solid region and each cutout within each thermal barrier have a dimension that is perpendicular to the plane and extends between the corresponding adjacent cells.

A method for manufacturing battery cell thermal barriers from aerogel includes (i) unrolling an aerogel coil; (ii) cutting blanks from the coil; and (iii) stamping each blank to form at least two battery cell thermal barriers from each blank such that each of the at least two battery cell thermal barriers formed by each blank has interconnected solid regions and defines voids between at least a portion of the interconnected solid regions.

### BRIEF DESCRIPTION OF THE DRAWINGS

FIG. 1 is a schematic illustration of a representative powertrain of an electric vehicle;

FIG. 2 is a schematic illustration of a representative battery for the powertrain of the electric vehicle;

FIG. 3 is a first set of thermal barriers formed from for a single blank of material;

FIG. 4 is a second set of thermal barriers formed from a single blank of material;

FIG. 5 is a third set of thermal barriers formed from a single blank of material; and

FIG. 6 is a flowchart illustrating a method for forming the thermal barriers.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

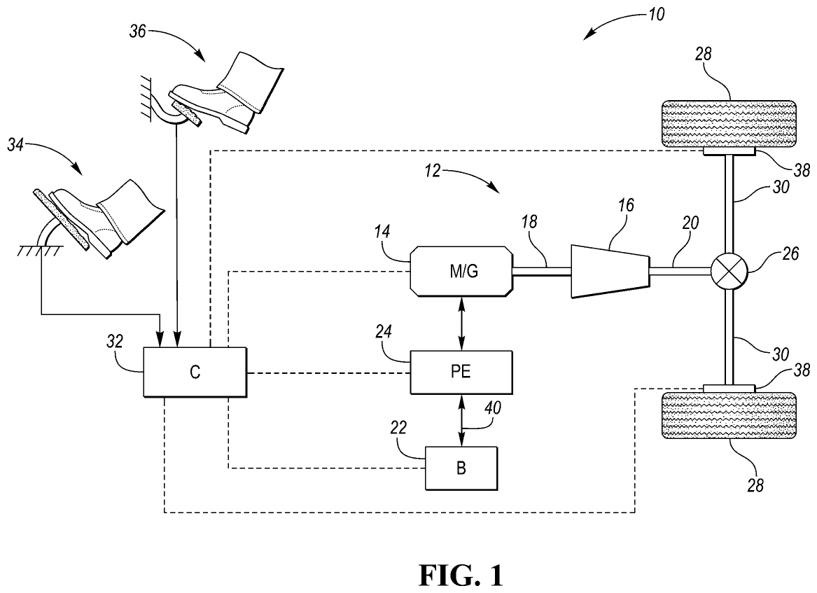

Referring to FIG. 1, a schematic diagram of an electric vehicle 10 is illustrated according to an embodiment of the present disclosure. FIG. 1 illustrates representative relationships among the components. Physical placement and orientation of the components within the vehicle may vary. The electric vehicle 10 includes a powertrain 12. The powertrain 12 includes an electric machine such as an electric motor/generator (M/G) 14 that drives a transmission (or gearbox) 16. More specifically, the M/G 14 may be rotatably connected to an input shaft 18 of the transmission 16. The transmission 16 may be placed in PRNDSL (park, reverse, neutral, drive, sport, low) via a transmission range selector (not shown). The transmission 16 may have a fixed gearing relationship that provides a single gear ratio between the input shaft 18 and an output shaft 20 of the transmission 16. A torque converter (not shown) or a launch clutch (not shown) may be disposed between the M/G 14 and the transmission 16. Alternatively, the transmission 16 may be a multiple step-ratio automatic transmission. An associated traction battery 22 is configured to deliver electrical power to or receive electrical power from the M/G 14.

The M/G 14 is a drive source for the electric vehicle 10 that is configured to propel the electric vehicle 10. The M/G 14 may be implemented by any one of a plurality of types of electric machines. For example, M/G 14 may be a permanent magnet synchronous motor. Power electronics 24 condition direct current (DC) power provided by the battery 22 to the requirements of the M/G 14, as will be described below. For example, the power electronics 24 may provide three phase alternating current (AC) to the M/G 14.

If the transmission 16 is a multiple step-ratio automatic transmission, the transmission 16 may include gear sets (not shown) that are selectively placed in different gear ratios by selective engagement of friction elements such as clutches and brakes (not shown) to establish the desired multiple discrete or step drive ratios. The friction elements are controllable through a shift schedule that connects and disconnects certain elements of the gear sets to control the ratio between the transmission output shaft 20 and the transmission input shaft 18. The transmission 16 is automatically shifted from one ratio to another based on various vehicle and ambient operating conditions by an associated controller, such as a powertrain control unit (PCU). Power and torque from the M/G 14 may be delivered to and received by transmission 16. The transmission 16 then provides powertrain output power and torque to output shaft 20.

It should be understood that the hydraulically controlled transmission 16, which may be coupled with a torque converter (not shown), is but one example of a gearbox or transmission arrangement; any multiple ratio gearbox that accepts input torque(s) from a power source (e.g., M/G 14) and then provides torque to an output shaft (e.g., output shaft 20) at the different ratios is acceptable for use with embodiments of the present disclosure. For example, the transmission 16 may be implemented by an automated mechanical (or manual) transmission (AMT) that includes one or more servo motors to translate/rotate shift forks along a shift rail to select a desired gear ratio. As generally understood by those of ordinary skill in the art, an AMT may be used in applications with higher torque requirements, for example.

As shown in the representative embodiment of FIG. 1, the output shaft 20 is connected to a differential 26. The differential 26 drives a pair of drive wheels 28 via respective axles 30 connected to the differential 26. The differential 26 transmits approximately equal torque to each wheel 28 while permitting slight speed differences such as when the vehicle turns a corner. Different types of differentials or similar devices may be used to distribute torque from the powertrain to one or more wheels. In some applications, torque distribution may vary depending on the particular operating mode or condition, for example.

The powertrain 12 further includes an associated controller 32 such as a powertrain control unit (PCU). While illustrated as one controller, the controller 32 may be part of a larger control system and may be controlled by various other controllers throughout the vehicle 10, such as a vehicle system controller (VSC). It should therefore be understood that the powertrain control unit 32 and one or more other controllers can collectively be referred to as a “controller” that controls various actuators in response to signals from various sensors to control functions such as operating the M/G 14 to provide wheel torque or charge the battery 22, select or schedule transmission shifts, etc. Controller 32 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the engine or vehicle.

The controller 32 communicates with various vehicle sensors and actuators via an input/output (I/O) interface (including input and output channels) that may be implemented as a single integrated interface that provides various raw data or signal conditioning, processing, and/or conversion, short-circuit protection, and the like. Alternatively, one or more dedicated hardware or firmware chips may be used to condition and process particular signals before being supplied to the CPU. As generally illustrated in the representative embodiment of FIG. 1, controller 32 may communicate signals to and/or receive signals from the M/G 14, battery 22, transmission 16, power electronics 24, and any another component of the powertrain 12 that may be included, but is not shown in FIG. 1 (i.e., a launch clutch that may be disposed between the M/G 14 and the transmission 16. Although not explicitly illustrated, those of ordinary skill in the art will recognize various functions or components that may be controlled by controller 32 within each of the subsystems identified above. Representative examples of parameters, systems, and/or components that may be directly or indirectly actuated using control logic and/or algorithms executed by the controller 32 include front-end accessory drive (FEAD) components such as an alternator, air conditioning compressor, battery charging or discharging, regenerative braking, M/G 14 operation, clutch pressures for the transmission gearbox 16 or any other clutch that is part of the powertrain 12, and the like. Sensors communicating input through the I/O interface may be used to indicate wheel speeds (WS1, WS2), vehicle speed (VSS), coolant temperature (ECT), accelerator pedal position (PPS), ignition switch position (IGN), ambient air temperature (e.g., ambient air temperature sensor 33), transmission gear, ratio, or mode, transmission oil temperature (TOT), transmission input and output speed, deceleration or shift mode (MDE), battery temperature, voltage, current, or state of charge (SOC) for example.

Control logic or functions performed by controller 32 may be represented by flow charts or similar diagrams in one or more figures. These figures provide representative control strategies and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but is provided for case of illustration and description. The control logic may be implemented primarily in software executed by a microprocessor-based vehicle and/or powertrain controller, such as controller 32. Of course, the control logic may be implemented in software, hardware, or a combination of software and hardware in one or more controllers depending upon the particular application. When implemented in software, the control logic may be provided in one or more computer-readable storage devices or media having stored data representing code or instructions executed by a computer to control the vehicle or its subsystems. The computer-readable storage devices or media may include one or more of a number of known physical devices which utilize electric, magnetic, and/or optical storage to keep executable instructions and associated calibration information, operating variables, and the like.

An accelerator pedal 34 is used by the driver of the vehicle to provide a demanded torque, power, or drive command to the powertrain 12 (or more specifically M/G 14) to propel the vehicle. In general, depressing and releasing the accelerator pedal 34 generates an accelerator pedal position signal that may be interpreted by the controller 32 as a demand for increased power or decreased power, respectively. A brake pedal 36 is also used by the driver of the vehicle to provide a demanded braking torque to slow the vehicle. In general, depressing and releasing the brake pedal 36 generates a brake pedal position signal that may be interpreted by the controller 32 as a demand to decrease the vehicle speed. Based upon inputs from the accelerator pedal 34 and brake pedal 36, the controller 32 commands the torque and/or power to the M/G 14, and friction brakes 38. The controller 32 also controls the timing of gear shifts within the transmission 16.

The M/G 14 may act as a motor and provide a driving force for the powertrain 12. To drive the vehicle with the M/G 14 the traction battery 22 transmits stored electrical energy through wiring 40 to the power electronics 24 that may include inverter and rectifier circuitry, for example. The inverter circuitry of the power electronics 24 may convert DC voltage from the battery 22 into AC voltage to be used by the M/G 14. The rectifier circuitry of the power electronics 24 may convert AC voltage from the M/G 14 into DC voltage to be stored with the battery 22. The controller 32 commands the power electronics 24 to convert voltage from the battery 22 to an AC voltage provided to the M/G 14 to provide positive or negative torque to the input shaft 18.

The M/G 14 may also act as a generator and convert kinetic energy from the powertrain 12 into electric energy to be stored in the battery 22. More specifically, the M/G 14 may act as a generator during times of regenerative braking in which torque and rotational (or kinetic) energy from the spinning wheels 28 is transferred back through the transmission 16 and is converted into electrical energy for storage in the battery 22.

It should be understood that the vehicle configuration described herein is merely exemplary and is not intended to be limited. Other electric or hybrid electric vehicle configurations should be construed as disclosed herein. Other electric or hybrid vehicle configurations may include, but are not limited to, series hybrid vehicles, parallel hybrid vehicles, series-parallel hybrid vehicles, plug-in hybrid electric vehicles (PHEVs), fuel cell hybrid vehicles, battery operated electric vehicles (BEVs), or any other vehicle configuration known to a person of ordinary skill in the art.

In hybrid configurations that include an internal combustion engine such as a gasoline, diesel, or natural gas powered engine, or a fuel cell, the controller 32 may be configured to control various parameters of such an internal combustion engine. Representative examples of internal combustion parameters, systems, and/or components that may be directly or indirectly actuated using control logic and/or algorithms executed by the controller 32 include fuel injection timing, rate, and duration, throttle valve position, spark plug ignition timing (for spark-ignition engines), intake/exhaust valve timing and duration, etc. Sensors communicating input through the I/O interface from such an internal combustion engine to the controller 32 may be used to indicate turbocharger boost pressure, crankshaft position (PIP), engine rotational speed (RPM), intake manifold pressure (MAP), throttle valve position (TP), exhaust gas oxygen (EGO) or other exhaust gas component concentration or presence, intake air flow (MAF), etc.

It should be understood that the schematic illustrated in FIG. 1 is merely representative and is not intended to be limiting. Other configurations are contemplated without deviating from the scope of the disclosure. For example, the vehicle powertrain 12 may be configured to deliver power and torque to the one or both of the front wheels as opposed to the illustrated rear wheels 28.

As the range of electric vehicles increases, more battery cells may be connected in parallel in battery packs. If one or more cells are experiencing thermal runaway, where the temperature of the cell is significantly increasing to levels higher than operable temperatures, electrical energy may transfer from the other cells to a cell that is experiencing the thermal runaway, resulting in further temperature increases in the cell experiencing the thermal runaway. Some of the heat from the cell that is experiencing thermal runaway may then be transferred to the other cells through the parallel connections. In order to slow down such thermal propagation between the battery cells, insulating materials may be disposed between cells.

In electric vehicle power systems, thermal barriers may be used to separate two adjacent battery cells inside the battery pack to delay or even stop thermal runaway propagation. Acrogel may be used due to its low thermal conductivity. Acrogel shield or pads may be sandwiched between adjacent battery cells. Acrogel shields or pads that contact the entire side surfaces of adjacent cells may be used. However, hundreds of aerogel pads may be needed for each vehicle battery pack and aerogel pads are relatively more costly when compared to Mica or foam. Therefore, it is desired to develop cost-effective thermal barrier.

Air is essentially a no-cost material and has a comparable thermal conductivity as aerogel. Air insulation was widely used in engine exhaust systems to reduce heat transfer and reduce engine cold start emissions. This disclosure is related to systems and methods for incorporating an air gap into the aerogel pad to reduce the material cost of thermal barrier. More specifically, single aerogel shield or pad blanks may be cut or stamped into several shields or pads that include regions of aerogel material separated by voids or spaces forming air gaps.

There are two types of commercial aerogel blanket manufacturing methods. A first is the called monolith blanket method. In the monolith blanket method, the silica aerogel precursor is immersed in a glass fiber mat before gelation. Therefore, the liquid solution can fill all the gap in the glass fiber mat. A gelation then occurs followed by super critical drying. The second method is to use premade aerogel powders and inject the powder into the glass fiber mat. In this second method the aerogel powder would flow around and fill the gaps within the glass fiber mat.

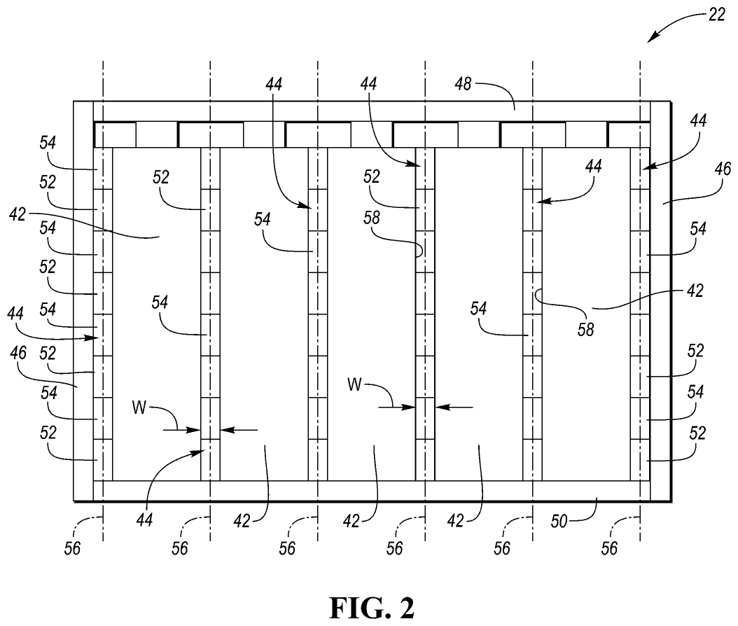

Referring to FIG. 2, a first schematic illustration of the battery 22 is illustrated. The battery 22 includes a plurality of cells 42 that are configured to store electrical energy and to discharge the electrical energy to the M/G 14 to propel the vehicle 10. The cells 42 may be arranged in cell banks having subsets of cells. The subsets of cells within each cell bank may be arranged or electrically connected to each other in parallel. More specifically, positive terminals within each cell bank are connected to each other via electrical connections and negative terminals within each cell bank are connected to each other via electrical connections such that the cells within each cell bank are electrically connected in parallel. The cell banks in turn may be arranged or electrically connected to each other in series. More specifically, adjacent cell banks may be connected to each other via electrical connections that connect a positive terminal of one cell bank to a negative terminal another cell bank.

The battery 22 further includes a plurality of thermal barriers 44. Each thermal barrier 44 may be disposed between adjacent cells 42 or between adjacent cell banks. The battery 22 may also include end plates 46. The battery 22 may also include a top plate 48, a bottom plate 50, and side plates. The end plates 46, top plate 48, bottom plate 50, and side plates may form a case or housing that encases the cells 42 and thermal barriers 44. The side plates have been removed in FIG. 2 for illustrative purposes. Thermal barriers 44 may also be disposed between the end plates 46 and an adjacent cell 42; the top plate 48 and tops of the cells 42; the bottom plate 50 and bottoms of the cells 42; and the side plates and sides of the cells 42.

The thermal barriers 44 may be comprised of an insulating material that is configured to restrict heat transfer, an endothermic material that is configured to absorb heat, or a combination of such materials. The properties and composition of the thermal barriers 44 may vary within the battery 22. For example, some of the thermal barriers 44 may only include an insulating material, some thermal barriers 44 may only include an endothermic material, and some thermal barriers 44 may include both insulating and endothermic materials. More specifically, the thermal barriers 44 may be comprised of an aerogel material.

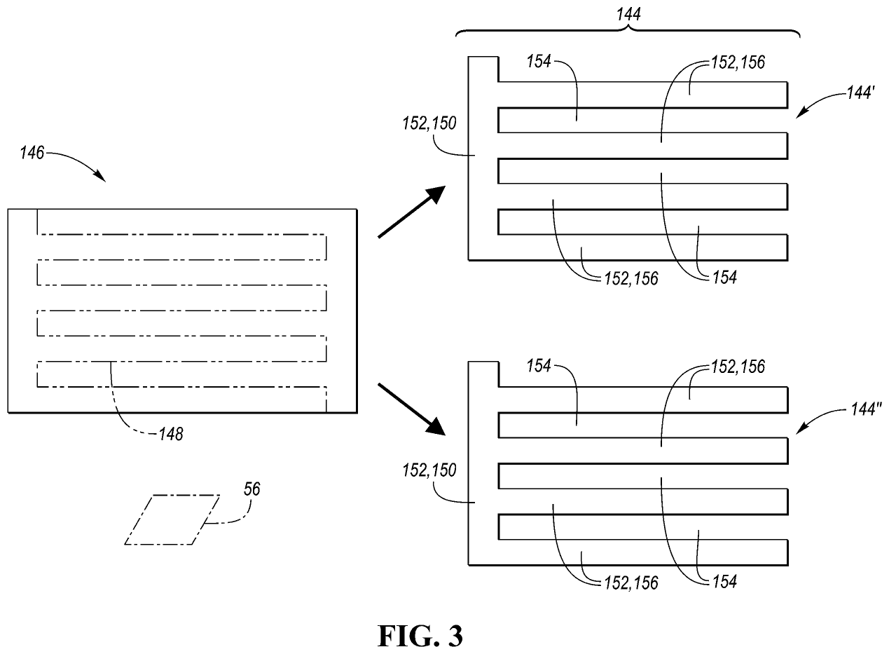

Each thermal barrier 44 includes solid regions 52. Each thermal barrier 44 defines openings, voids, or cutouts 54 between the solid regions 52. The solid regions 52 within each thermal barrier 44 may be aligned along a plane 56. The solid regions 52 may also be referred to as planar regions since the solid region 52 are aligned along planes 56 within each thermal barrier 44. Each cutout 54 within each thermal barrier 44 may also be aligned along a corresponding plane 56. It is noted that the planes 56 representing the planar arrangement of each thermal barrier 44 are going into the sheet in FIG. 2 and are therefore illustrated as lines. The planes 56 are further illustrated as being oriented along the sheets in FIGS. 3-5. Since the solid regions 52 and the cutouts 54 may each be aligned along a common plane 56 within each thermal barrier 44, the solid regions 52 and the cutouts 54 may be in a coplanar alignment, coplanar arrangement, or coplanar relationship with each other within each thermal barrier 44. The solid regions 52 may be made from aerogel and the cutouts may correspond to air gaps.

Each thermal barrier 44 may be disposed within a gap 58 defined between adjacent cells 42 or between one or more of the cells 42 and one or more of the elements forming the case or housing that encases the cells 42 (e.g., the end plates 46, top plate 48, bottom plate 50, and side plates). Each of the solid regions 52 and the cutouts 54 within each thermal barrier 44 may extend transversely between the corresponding adjacent cells 42 (or between one or more of the cells 42 and one or more of the elements forming the case or housing that encases the cells 42) orthogonally to the coplanar arrangement. Stated in other terms, of the solid regions 52 and the cutouts 54 within each thermal barrier 44 have a dimension (e.g., a width, W) that is substantially perpendicular to the common plane 56 within each thermal barrier 44. The dimension extends between the corresponding adjacent cells 42 (or between one or more of the cells 42 and one or more of the elements forming the case or housing that encases the cells 42). As used herein, substantially perpendicular refers to any incremental angle that is between exactly perpendicular and 15° or less from exactly perpendicular (e.g., 12.5° or less from exactly perpendicular, 10° or less from exactly perpendicular, 5° or less from exactly perpendicular, 2.5° or less from exactly perpendicular, 1° or less from exactly perpendicular, 0.5° or less from exactly perpendicular, 0.25° or less from exactly perpendicular, 0.1° or less from exactly perpendicular, etc.).

It should be understood that the image in FIG. 2 is for illustrative purposes only and that the battery 22 may include any number of cells 42, may include any number of thermal barriers 44, the positions of the solid regions 52 may be rearranged based on the configuration of the thermal barrier 44, and the positions of the cutouts 54 may be rearranged based on the configuration of the thermal barrier 44.

Referring to FIG. 3, a first set of thermal barriers 144 formed from a single blank 146 of material is illustrated. The first set of thermal barriers 144 includes a first thermal barrier 144′ and second thermal barrier 144″ each defining air gaps. This configuration effectively reduces material costs by half since the single blank 146 of material is utilized as two thermal barriers (e.g., the first thermal barrier 144′ and the second thermal barrier 144″) as opposed to one thermal barrier (e.g., the undivided single blank 146 of material).

The first thermal barrier 144′ and the second thermal barrier 144″ include solid regions 152 and define cutouts 154. It should be understood that one or more of the sets of thermal barriers 144 may be utilized as the thermal barriers 44 illustrated in FIG. 2, and that the solid regions 152 and cutouts 154 illustrated in FIG. 3 may correspond to the solid regions 52 and cutouts 54 illustrated in FIG. 2, respectively. Furthermore, the blank 146, the first thermal barrier 144′, and the second thermal barrier 144″ may be made from aerogel. The first thermal barrier 144′ and second thermal barrier 144″ may be made by cutting, punching, stamping, or other process where the blank 146 of material is cut, punched, or stamped along cut lines 148 to form the first thermal barrier 144′ and the second thermal barrier 144″. The first thermal barrier 144′ and the second thermal barrier 144″ may collectively include all of the material from the blank 146 of material such that none of the original material from the blank 146 is wasted.

Each of the first thermal barrier 144′ and second thermal barrier 144″ may include a primary region 150 aligned along a corresponding coplanar arrangement or plane 56 of the respective thermal barrier and a plurality of secondary regions 156 that are also aligned along the corresponding coplanar arrangement or plane 56 of the respective thermal barrier. The secondary regions 156 within each thermal barrier (e.g., the first thermal barrier 144′ and second thermal barrier 144″) may extending orthogonally or substantially perpendicular from the primary region 150. The secondary regions 156 may be spaced-apart relative to each other within each thermal barrier such that the cutouts 154 are defined between the secondary regions 156 within each thermal barrier. The primary region 150 within each thermal barrier may be rectangular in shape. The secondary regions 156 within each thermal barrier may also be rectangular in shape.

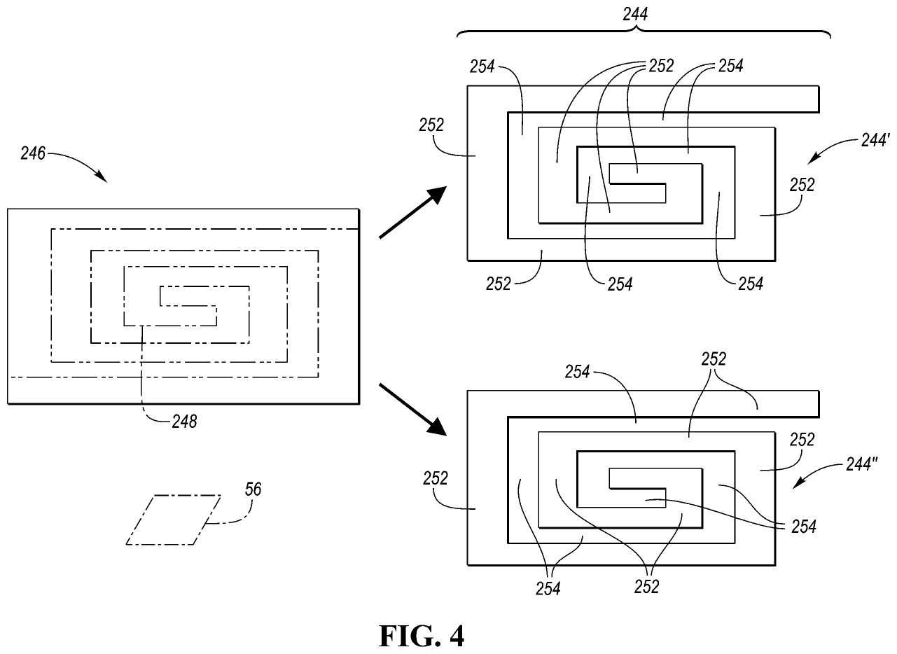

Referring to FIG. 4, a second set of thermal barriers 244 formed from a single blank 246 of material is illustrated. The second set of thermal barriers 244 includes a first thermal barrier 244′ and second thermal barrier 244″ each defining air gaps. This configuration effectively reduces material costs by half since the single blank 246 of material is utilized as two thermal barriers (e.g., the first thermal barrier 244′ and the second thermal barrier 244″) as opposed to one thermal barrier (e.g., the undivided single blank 246 of material).

The first thermal barrier 244′ and the second thermal barrier 244″ include solid regions 252 and define cutouts 254. It should be understood that one or more of the sets of thermal barriers 244 may be utilized as the thermal barriers 44 illustrated in FIG. 2, and that the solid regions 252 and cutouts 254 illustrated in FIG. 4 may correspond to the solid regions 52 and cutouts 54 illustrated in FIG. 2, respectively. Furthermore, the blank 246, the first thermal barrier 244′, and the second thermal barrier 244″ may be made from aerogel. The first thermal barrier 244′ and second thermal barrier 244″ may be made by cutting, punching, stamping, or other process where the blank 246 of material is cut, punched, or stamped along cut lines 248 to form the first thermal barrier 244′ and the second thermal barrier 244″. The first thermal barrier 244′ and the second thermal barrier 244″ may collectively include all of the material from the blank 246 of material such that none of the original material from the blank 246 is wasted.

The solid regions 252 within each thermal barrier (first thermal barrier 244′ and the second thermal barrier 244″) may be arranged into a spiral or spiral-shape along the coplanar arrangement or plane 56. The cutouts 254 within each thermal barrier (first thermal barrier 244′ and the second thermal barrier 244″) may also be arranged into a spiral or spiral-shape along the coplanar arrangement or plane 56. Sections of the solid regions 252 and cutouts 254 may be rectangular in shape.

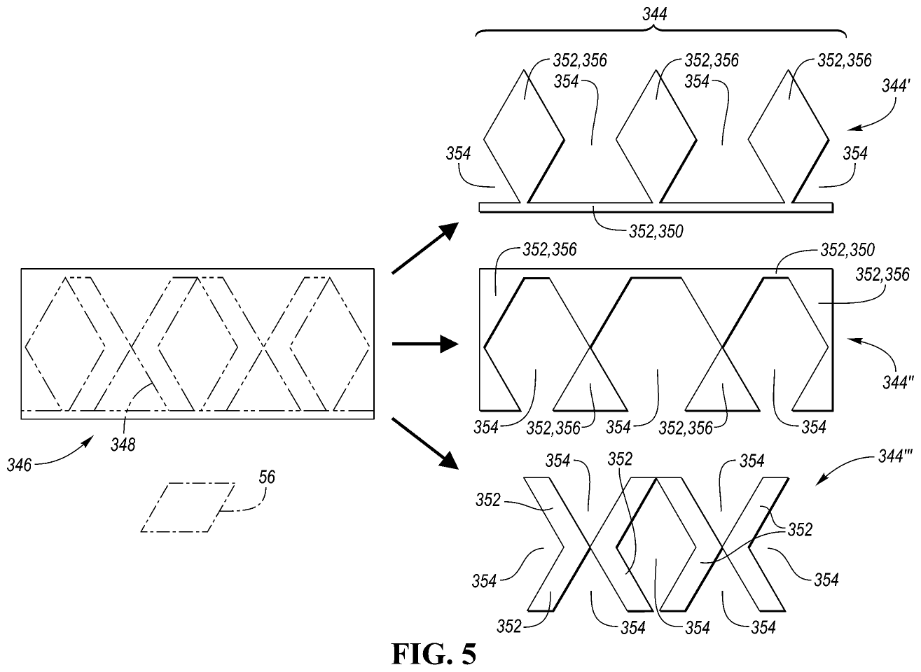

Referring to FIG. 5, a third set of thermal barriers 344 formed from a single blank 346 of material is illustrated. The third set of thermal barriers 344 includes a first thermal barrier 344′, a second thermal barrier 344″, and a third thermal barrier 344″ each defining air gaps. This configuration effectively reduces material costs by two-thirds since the single blank 346 of material is utilized as three thermal barriers (e.g., the first thermal barrier 344′, the second thermal barrier 344″, and the third thermal barrier 344″) as opposed to one thermal barrier (e.g., the undivided single blank 346 of material).

The first thermal barrier 344′, the second thermal barrier 344″, and the third thermal barrier 344′″ include solid regions 352 and define cutouts 354. It should be understood that one or more of the sets of thermal barriers 344 may be utilized as the thermal barriers 44 illustrated in FIG. 2, and that the solid regions 352 and cutouts 354 illustrated in FIG. 5 may correspond to the solid regions 52 and cutouts 54 illustrated in FIG. 2, respectively. Furthermore, the blank 346, the first thermal barrier 344′, the second thermal barrier 344″, and the third thermal barrier 344″ may be made from aerogel. The first thermal barrier 344′, the second thermal barrier 344″, and the third thermal barrier 344″ may be made by cutting, punching, stamping, or other process where the blank 346 of material is cut, punched, or stamped along cut lines 348 to form the first thermal barrier 344′, the second thermal barrier 344″, and the third thermal barrier 344″. The first thermal barrier 344′, the second thermal barrier 344″, and the third thermal barrier 344″ may collectively include all of the material from the blank 346 of material such that none of the original material from the blank 346 is wasted.

Each of the first thermal barrier 344′ and the second thermal barrier 344″ may include a primary region 350 aligned along a corresponding coplanar arrangement or plane 56 of the respective thermal barrier and a plurality of secondary regions 356 that are also aligned along the corresponding coplanar arrangement or plane 56 of the respective thermal barrier.

The secondary regions 356 within each thermal barrier of the first thermal barrier 344′ and the second thermal barrier 344″ may extending orthogonally or substantially perpendicular from the primary region 350. The secondary regions 356 may be spaced-apart relative to each other within each thermal barrier of the first thermal barrier 344′ and the second thermal barrier 344″ such that the cutouts 354 are defined between the secondary regions 356 within each thermal barrier of the first thermal barrier 344′ and the second thermal barrier 344″. The primary region 350 within each thermal barrier may also be rectangular in shape. The secondary regions 356 within the first thermal barrier 344′ may be diamond shaped while the secondary regions 356 within the second thermal barrier 344″ may be hourglass shaped. The solid regions 352 of the third thermal barrier 344″ may be X-shaped. The cutouts 354 of the third thermal barrier 344″ may be defined along the exterior of each X-shaped solid region 352 and between adjacent X-shaped solid regions 352.

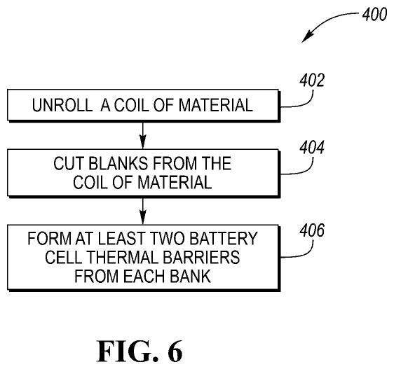

Referring to FIG. 6 a flowchart illustrating a method 400 for forming a thermal barrier (e.g., thermal barriers 44, 144′, 144″, 244′, 244″ 344′, 344″, 344″) is illustrated. The method begins at block 402 where a roll or coil of material (e.g., a coil or roll of aerogel) is unrolled. Next, at block 404 blanks (e.g., blanks 146, 246, 346) are cut from the roll or coil of material. Once the blanks are cut, the method 400 moves on to block 406 where each blank is cut, punched, or stamped to form at least two battery cell thermal barriers from each blank. The at least two battery cell thermal barriers formed by each blank have interconnected solid regions (e.g., solid regions 52, 152, 252, 352) regions and define voids or cutouts (e.g., cutouts 54, 154, 254, 354) between at least a portion of the interconnected solid regions.

It should be understood that the flowchart in FIG. 6 is for illustrative purposes only and that the method 400 should not be construed as limited to the flowchart in FIG. 6. Some of the steps of the method 400 may be rearranged while others may be omitted entirely.

It should be understood that the designations of first, second, third, fourth, etc. for any component, state, or condition described herein may be rearranged in the claims so that they are in chronological order with respect to the claims. Furthermore, it should be understood that any component, state, or condition described herein that does not have a numerical designation may be given a designation of first, second, third, fourth, etc. in the claims if one or more of the specific component, state, or condition are claimed.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. A battery for an electrically powered vehicle comprising:
a plurality of cells configured to store electrical energy and discharge the electrical energy to propel the vehicle; and
a plurality of thermal barriers disposed between adjacent cells of the plurality of cells, wherein (i) each thermal barrier includes planar regions, (ii) each thermal barrier defines voids between the planar regions, (iii) each planar region and each void within each thermal barrier are aligned in a coplanar arrangement within a gap defined between the corresponding adjacent cells, and (iv) each planar region and each void within each thermal barrier extend transversely between the corresponding adjacent cells orthogonally to the coplanar arrangement.

2. The battery of claim 1, wherein each planar region within at least a portion of the thermal barriers includes (i) a primary region aligned along a corresponding coplanar arrangement and (ii) a plurality of secondary regions aligned along the corresponding coplanar arrangement and extending orthogonally from the primary region.

3. The battery of claim 2, wherein the secondary regions are spaced-apart relative to each other such that the voids are defined between the secondary regions.

4. The battery of claim 2, wherein at least a portion the secondary regions are rectangular in shape.

5. The battery of claim 2, wherein at least a portion the secondary regions are diamond shaped.

6. The battery of claim 2, wherein at least a portion the secondary regions are hourglass shaped.

7. The battery of claim 1, wherein the planar regions within each thermal barrier are arranged into a spiral along the coplanar arrangement.

8. The battery of claim 1, wherein voids within each thermal barrier are arranged into a second spiral along the coplanar arrangement.

9. The battery of claim 1, wherein at least a portion of the planar regions are X-shaped.

10. The battery of claim 1, wherein the planar regions are comprised of aerogel.

11. A battery comprising:
a plurality of cells configured to store electrical energy; and
a plurality of thermal barriers each disposed between adjacent cells of the plurality of cells, wherein each thermal barrier (i) includes solid regions, (ii) defines cutouts between the solid regions, (iii) each solid region and each cutout within each thermal barrier are aligned along a plane, and (iv) each solid region and each cutout within each thermal barrier have a dimension that is perpendicular to the plane and extends between the corresponding adjacent cells.

12. The battery of claim 11, wherein each solid region within at least a portion of the thermal barriers includes (i) a primary region aligned along a corresponding plane and (ii) a plurality of secondary regions aligned along the corresponding plane and extending from the primary region.

13. The battery of claim 12, wherein the secondary regions are spaced-apart relative to each other such that the cutouts are defined between the secondary regions.

14. The battery of claim 12, wherein at least a portion the secondary regions are rectangular in shape.

15. The battery of claim 12, wherein at least a portion the secondary regions are diamond shaped.

16. The battery of claim 12, wherein at least a portion the secondary regions are hourglass shaped.

17. The battery of claim 11, wherein the solid regions within each thermal barrier are arranged into a spiral along the plane.

18. The battery of claim 11, wherein at least a portion of the solid regions are X-shaped.

19. The battery of claim 11, wherein the solid regions are comprised of aerogel.

20. A method for manufacturing battery cell thermal barriers from aerogel comprising:
unrolling an aerogel coil;
cutting blanks from the coil; and
stamping each blank to form at least two battery cell thermal barriers from each blank such that each of the at least two battery cell thermal barriers formed by each blank (i) has interconnected solid regions and (ii) defines voids between at least a portion of the interconnected solid regions.
